(19) United States
(12) Patent Application Publication
(10) Pub. No.: US 2019/0171426 A1
(43) Pub. Date: Jun. 6, 2019

(54) PROGRAM COMPILER AND LINKER, AND METHOD

(71) Applicant: Sony Interactive Entertainment Inc., Tokyo (JP)

(72) Inventor: Paul Bowen-Hugget, Bristol (GB)

(73) Assignee: Sony Interactive Entertainment Inc., Tokyo (JP)

(21) Appl. No.: 16/309,972

(22) PCT Filed: May 31, 2017
(86) PCT No.: PCT/GB2017/051556

§ 371 Date: Dec. 14, 2018

(30) Foreign Application Priority Data
Jul. 21, 2016 (GB) 1612650.0

(51) Int. Cl. G06F 8/41; G06F 11/36; H04L 9/06

(52) U.S. Cl. CPC G06F 8/48; H04L 9/0643; G06F 11/3624; G06F 8/4443

(57) ABSTRACT

Methods and apparatus include: obtaining a source code element from source code, obtaining compiler options for compilation of the source code element, applying a hash function to data representing the source code element and compiler options to generate a first hash value specific to the combination of the source code element and compiler options, and searching a repository for the first hash value. If the first hash value is not found in the repository, generating an object code fragment from the source code element using the compiler options, and storing the generated object code fragment and first hash value in association with each other in the repository. If the first hash value is found in the repository, not generating an object code fragment from the source code element; generating a list identifying one or more object code fragments in the repository that when suitably combined form object code for the source code, receiving at a linker data identifying one or more object code fragments, the object code fragments each corresponding to a source code element compiled according to respective compiler options, accessing the or each identified object code fragment from a repository of object code fragments, and commencing a memory layout mapping of object code fragments to addresses.

The present invention relates to a program compiler and linker, and method.

### BACKGROUND

Statically compiled languages such as C and C++ are used widely, and are particularly dominant in fields such as such as video games and embedded systems where high performance code is of particular importance. However, the basic structure of the compilation system has used by such languages has remained largely unchanged since the earliest days of the C programming language itself. As programs grow in both size and complexity, this structure leads to inefficiencies that can impact on productivity.

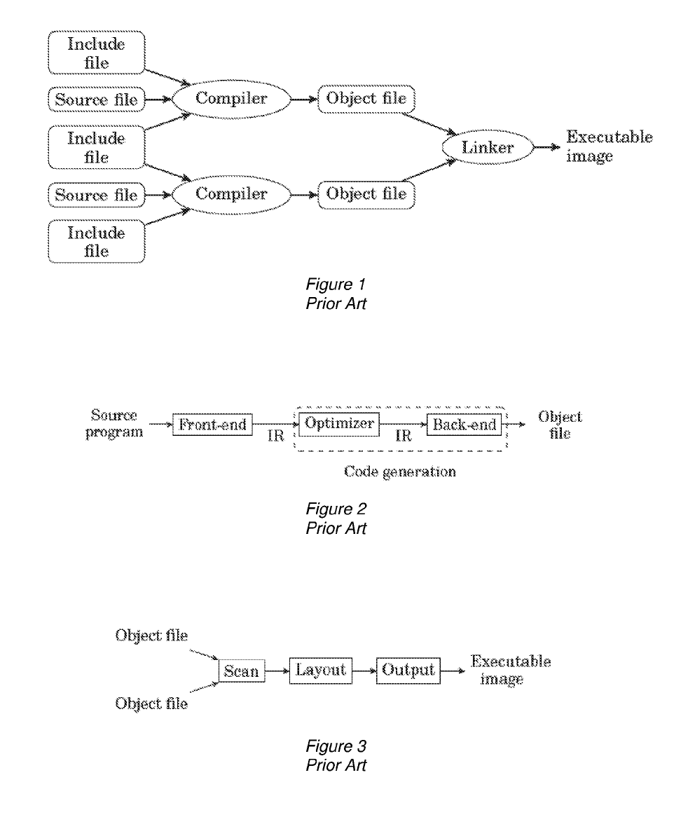

In more detail and referring to FIG. 1, a conventional compiler or assembler system takes a file containing the user's source code and produces an object file containing all of the entities defined by that code. Typically the source code is divided between one or more translation units (TUs), along with any necessary libraries identified by an include file, and the output object files are subsequently linked together to produce the final output which is suitable for execution.

Referring to FIG. 2, the compiler itself typically uses a three-stage process to generate object code from the source code. The ‘front-end’ stage provides lexical analysis and parsing of the source code to generate an intermediate representation (IR) which is suitable for input to subsequent phases. The ‘optimizer’ stage implements series of optimization passes that receive, modify and produce IRs. Finally, the ‘back-end’ stage implements target-dependent operations such as instruction selection, register allocation, and scheduling. The resulting binary is then written to an output object file suitable for linking. The entire translation unit passes through the optimization and back-end phases.

Referring to FIG. 3, the linker similarly uses a three-stage process to generate the final executable. The ‘scan’ stage examines each of the object files and gathers information such as the types and size of the data section that they contain, and the symbols defined and referenced by the file. The ‘layout’ stage assigns addresses to each of the loadable sections that were discovered during the scan phase, applying any restrictions required by the target operating system. Finally, the ‘output’ stage copies all of the required data from the input object files to the output executable image. It applies “relocations” (or “fixups”) that enable one object file to reference data defined in another.

However, this traditional arrangement can lead to poor performance in the form of duplicated effort, for several reasons.

Firstly, when a translation unit is compiled, the compiler processes it in its entirety; all of the stages of translation from source code to intermediate representation, all of the optimization passes, and the final code generation and object file emission are performed, even if the majority of the source code has not been changed between compilations (‘builds’). As a result a large proportion of the source code is compiled needlessly.

Whilst it is possible to mitigate this to an extent by choosing how to assign code in translation units, this is limited by the structure of a program's source code and overall size.

Secondly, variables are frequently duplicated (and subsequently de-duped) due to the common practice in many programming languages of only defining variables, functions and the like once within source code that is then subsequently divided up into TUs. This results in TUs comprising objects that are locally undefined. One term for these objects is that they have ‘vague linkage’.

In order to proceed, temporary definitions are created for such TUs, but these then have to be identified and discarded by the linker once the original definition is found amongst the compiled object files.

Thirdly, the division of code into TUs results in duplication and increased complexity of debug information generated during the compilation process. For example, commonly included library functions will be repeated in debug data for multiple TUs.

In response to these problems, there have been attempts to reduce or optimise the source code text that is input to the compiler in order to improve efficiency. Similarly there have been attempts to parallelise the compilation of TUs, and also attempts to de-dupe generated debug information. However, these approaches to not affect that basic compilation approach itself, and so the fundamental causes of poor performance remain. Addressing these using an alternative approach should nevertheless preferably support existing source code with little or no change, and similarly the ecosystem of tools that surround the compiling system, such as debugging tools, should also preferably require little or no change.

The present invention aims to address or mitigate the above problem.

### SUMMARY OF INVENTION

In a first aspect, a compiling and linking method is provided in accordance with claim 1.

In another aspect, a compiler and linker is provided in accordance with claim 10.

Further respective aspects and features of the invention are defined in the appended claims.

Embodiments of the present invention will now be described by way of example with reference to the accompanying drawings, in which:

FIG. 1 is a schematic diagram of a compiler and linker system known in the art.

FIG. 2 is a schematic diagram of a compiler known in the art.

FIG. 3 is a schematic diagram of a linker known in the art.

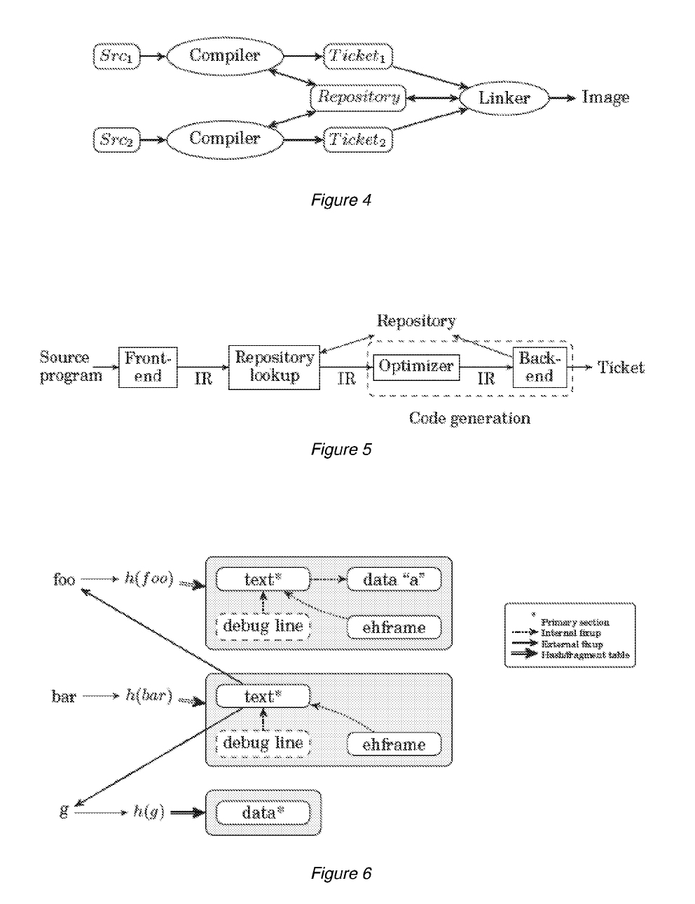

FIG. 4 is a schematic diagram of a compiling system in accordance with an embodiment of the present invention.

FIG. 5 is a schematic diagram of a compiler in accordance with an embodiment of the present invention.

FIG. 6 is a schematic diagram of program fragments in a repository, in accordance with an embodiment of the present invention.

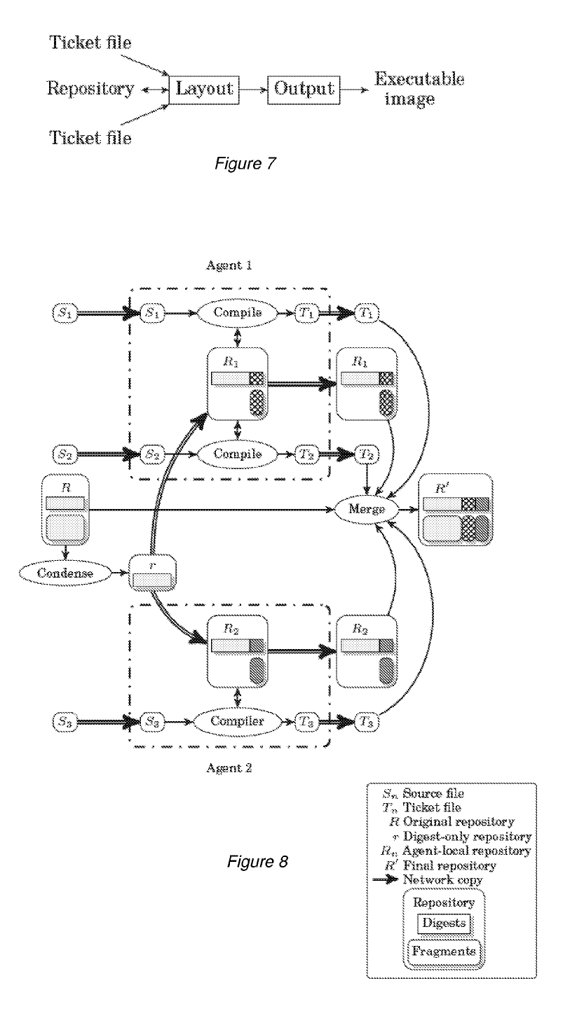

FIG. 7 is a schematic diagram of a linker in accordance with an embodiment of the present invention.

FIG. 8 is a schematic diagram of a distributed compiler in accordance with an embodiment of the present invention.

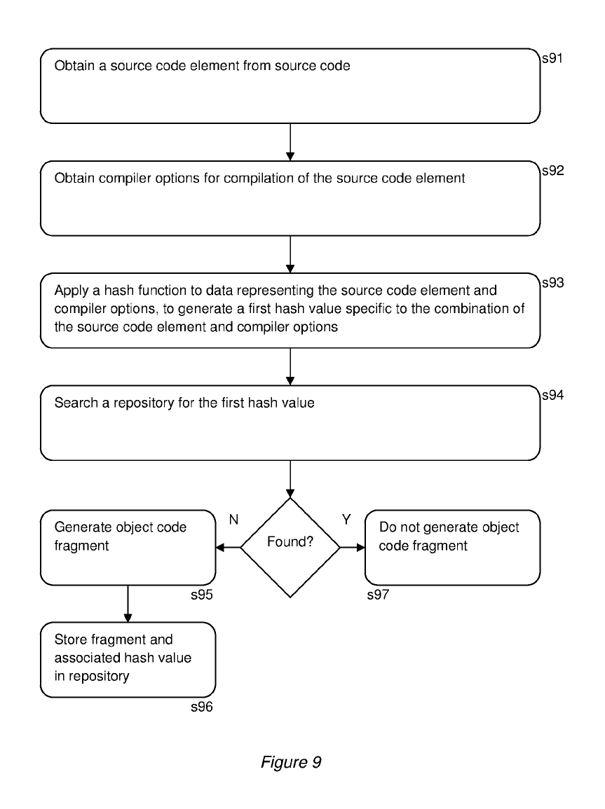

FIG. 9 is a flow diagram of a compiling method for a compiler, in accordance with an embodiment of the present invention.

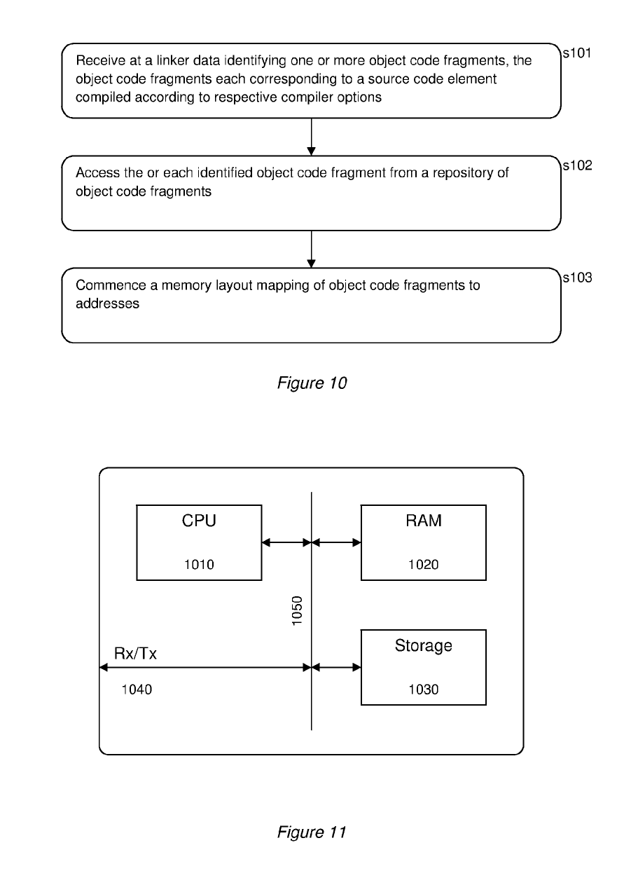

FIG. 10 is a flow diagram of a linking method for a linker, in accordance with an embodiment of the present invention.

FIG. 11 is a schematic diagram of a computer.

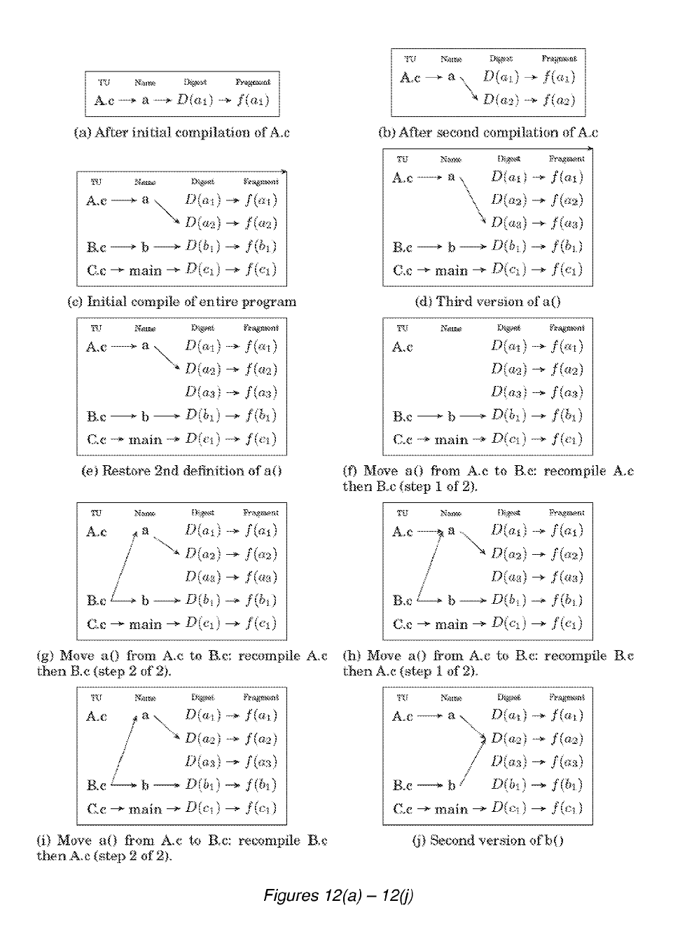

FIGS. 12(a)-12(j) are schematic diagrams of the contents of a program repository, in accordance with an embodiment of the present invention.

A program compiler and linker, and a method are disclosed. In the following description, a number of specific details are presented in order to provide a thorough understanding of the embodiments of the present invention. It will be apparent, however, to a person skilled in the art that these specific details need not be employed to practice the present invention. Conversely, specific details known to the person skilled in the art are omitted for the purposes of clarity where appropriate.

Compiler Overview

Referring now to FIGS. 4 and 5, in an embodiment of the present invention a compiler is arranged to obtain from source code an individual function or data item, and also obtains compiler options for compilation of the individual function or data item. It is then arranged to apply a hash function to data representing the individual function or data item and compiler options, thereby generating a first hash value specific to the combination of the individual function or data item and compiler options.

The compiler then searches a repository for the first hash value; if the first hash value is not found in the repository, the compiler is arranged to generate an object code fragment from the individual function or data item using the compiler options, and store the generated object code fragment and first hash value in association with each other in the repository.

By contrast, if the first hash value is found in the repository, then the compiler is arranged to not generate an object code fragment from the individual function or data item, thereby avoiding duplication of effort.

Compiler and Repository

This compiler is now discussed in more detail.

The compiler (and also the subsequent linker, co-operating as a compilation system) make use of a centralised program repository. Hence instead of a program being constructed by having the compiler produce a number of discrete object files which are assembled into an executable image by the linker, it has a centralised repository which contains data fragments that are a result of compiling some or all of the program.

The repository may be queried by various tools to enable them to, for example, avoid repeating optimisation and code-generation operations for pre-existing functions and data such as those that are unchanged or have vague linkage.

Consequently, the repository becomes the primary input to the linker, although of course other inputs may include externally defined entities such as third-party or dynamic libraries. The linker may use the repository were to record additional metadata necessary to support incremental linking. Other tools, such as profilers or debuggers, may also access the repository to discover and record information about the program.

Fragments

As will be explained herein, the repository stores so-called program fragments (or just ‘fragments’), together with associated data. Typically a fragment is generated from, and hence corresponds to, a basic unit of code from which a program is composed. Thus it typically corresponds to a single, self-contained, vertex in a digraph that forms a program. Example fragments include functions or static data objects, although clearly equivalent examples will be apparent to the skilled person, and may depend upon the language being compiled. Hence the portion of source code that corresponds to and gives rise to a fragment is typically a function or data item, and more generally may be thought of as a source code element.

A fragment as stored in the repository is made up of a collection of “sections”; each section holds a specific type of data or metadata. Again, the metadata may vary depending upon the language being compiled and upon selected compiler options. Example metadata includes information for language support such as exception handling or virtual method tables, and information for use by tools such as debugging information or dynamically captured data, run-time meta-data, thread-local data and the like.

In turn the fragments and sections are associated with so-called internal and external ‘fix-ups’, as necessary. External fix-ups form the edges in the program graph, whilst internal fix-ups define connections between the contents of the fragment's sections.

By way of example, for the source code of the simple C program listed below, the resulting three fragments, their internal sections, and the internal and external fix-ups are illustrated in FIG. 6.

int foo (void) {

static int a = 10;
return a++;

}
static int g = 31;
int bar (void) {

return foo ( ) + g++;

}

As can be seen from the above listing and FIG. 6, the source code comprises three source code elements (functions foo and bar, and independently defined variable g), which give rise to three interconnected program fragments. Each is assigned a unique, globally visible, name: foo and bar have external linkages and the provided names can be used. variable g has internal linkage, so a stable, unique, name is generated; any suitable naming scheme would suffice. In this example, the three fragments and their fixups would be stored in the repository.

Compilation

In contrast to the three-stage compilation process of a traditional compiler shown in FIG. 2, the use of the program repository results in a new system structure, as shown in FIG. 5. Most notably, the compiler no longer generates object code for the linker, but instead new code is placed in the repository and the compiler issues so-called ‘tickets’, which comprise or uniquely identify a list that in turn identifies the one or more object code fragments in the repository that when suitably combined would form the object code used by a linker.

In more detail, the program repository introduces a new pass either within, immediately or shortly following the front-end of the compiler.

As will be explained herein, this pass enables the compiler to avoid repeating code generation phases for those code elements for which a binary representation is already available, regardless of the translation unit for which this work was originally done. As noted above, typically this new pass will be placed close to the front-end of the compiler, but after decisions have been made by the compiler that affect the final generated code, such as inlining.

The pass also enables unnecessary intermediate representations (IRs) for unchanged objects or for objects with vague linkage and for which a compiled instance already exists to be avoided or removed as early as possible, thereby reducing overheads in the later phases of the compiler.

The pass operates as follows; a source code element (e.g. an individual function or data item or their equivalents, depending on the language) is obtained from the source code, together with information determining how the source code element will be compiled into generated code (such as compilation options, inlining decisions etc., as appropriate, hereafter collectively referred to as ‘compiler options’). Together these are applied to a hash function to generate a first hash value specific to the combination of the source code element and compiler options.

The source code element may be represented by an intermediate representation such as an abstract syntax tree (AST) or other formalism prior to the hashing process.

Notably therefore, the first hash value is generated before generation of object code, but will uniquely correlate with such generated object code, since this code is generated deterministically from the source code element and compiler options represented by the hash.

Each hash generated in this manner is compare to hashes stored in the repository in association with previously compiled code fragments.

If the first hash is not found, then it is assumed that the combination of code and compilation options is new, and so the source code, AST or other representation of the source code element is transformed into an intermediate representation (if required) that is suited to optimisation and code generation, and the fragment of object code is generated.

The generated object code fragment and first hash value are then stored in association with each other in the repository. Optionally other meta data such as a reference ID for the program fragment and debug data may also be stored in association.

By contrast, if the first hash value is found in the repository, then it is assumed that the same combination of code and compilation options has been used already to generate the intended object code, and so the steps of optimisation and generating an object code fragment from the individual function or data item are not performed.

This process is then repeated for each source code element in the source code that is required for compilation.

As noted above, when the compiler generates new object code, this is placed within the repository. Consequently the compiler does not output object code for the linker in the conventional sense. Instead, it generates a so-called ‘ticket’ file comprising one or more unique values (UUIDs). The UUIDs themselves can together act as a list identifying one or more object code fragments in the repository that when suitably combined form object code for the source code. In this case, a look-up table of UUIDs and program fragments can be maintained in the repository. Alternatively or in addition, a UUID can be used to identify such a list of program fragments that is itself stored in the repository as build metadata. The list can be assembled as the compiler progresses through the source code, when either creating new program fragments or identifying existing program fragments.

The ticket file comprising the one or more UUIDs may comprise a timestamp to assist build tools that use such timestamps for version control and the like.

The ticket is then provided to the linker, which uses the ticket (or a plurality of tickets, depending on the nature of the source code, language and/or compilation strategy) to gather the complete collection of program fragments that are to be included in the link.

Linker Overview

Referring now to FIGS. 4 and 7, in an embodiment of the present invention a linker is arranged to obtain data identifying one or more object code fragments (e.g. one or more tickets), the object code fragments each corresponding to a source code element compiled according to respective compiler options. The linker is arranged to then access the or each identified object code fragment from the repository of object code fragments, and to perform memory layout mapping of object code fragments to addresses.

Then, the binary data is copied to the appropriate positions and any needed fixups are applied to link the final code together.

Linker and Repository

In contrast to the three-stage linker of FIG. 3, the linker of FIG. 7 links from the program repository.

The linker begins by enumerating the collection of repository and ticket files obtained; the or each UUID contained within each ticket maps to the set of fragments that were produced by that compilation (including those items with vague linkage). This in turn defines the collection of fragments that are eligible for inclusion in the link.

The linker then begins the layout phase; this starts at the program entry points (such as _start for an executable or the list of exported names for a shared library) and traverses the program graph. As each fragment is visited, its sections are added to the relevant output stream (code, data, read-only data, and so on) and the corresponding address is recorded. The resulting mapping of fragments to addresses is then used in the output phase—as the data is being copied—to apply all of the necessary fixups to the output. These last output stages of linking are therefore relatively conventional and not discussed in detail herein.

Notably therefore by using the repository, the linker enjoys a number of advantages:

Firstly, by default the program fragments in the repository correspond to single vertices on the program digraph, as discussed previously. As a result, the fragments correspond with the graph representation of the program in a straightforward manner. The linker can therefore use available correspondences between a graph representation of the program and the object code fragments to detect connections between fragments, instead of performing a scan function of those object code fragments. This makes the scan phase of a conventional linker unnecessary, or at least greatly simplified (scanning may for example be employed when linking third party object code). Alternatively or in addition, scanning may optionally be performed a first time code is built, and the results may be associated with code fragments or a ticket list in the repository, so that only scanning for new program fragments and their direct links are performed subsequently.

Hence also advantageously, because by default the program fragments are typically much smaller than traditional blocks of object code, the adoption of an incremental link technique can be particularly efficient as only those source code elements that have actually been changed since the previous link need to be considered.

Finally, notably the linker does not need to handle sections/metadata of program fragments that are not required by the linker in the final executable; hence for example debugging data for a fragment can remain in the repository, and does not need to be copied by the linker since a debugger can access it directly from the repository itself.

Debugging

In an embodiment of the present invention, a debuggable executable image contains references to the originating repository (or repositories as explained later herein). The debugger loads the debugging metadata directly from the or each repository.

Debugging metadata may include:
Source-line correspondence,
Descriptions of the functions (program scope entries),
Type entries and types used in the program, and/or
Call-frame information.

Some of this information, such as the source-line correspondence or call-frame information, are associated with a particular function, and thus can optionally be stored with the relevant fragment as a metadata section.

Meanwhile other data, such as the type graph, can be viewed as forming a separate layer in the overall program graph. Following the scheme described in DWARF Standards Committee 2010 Appendix E, each type is a unique vertex in that graph; consequently a signature hash can be generated for the type and hash comparisons can be used to detect that the vertex is unique.

### VARIANT EMBODIMENT

Distributed Compilation and Linking

As compilation proceeds, the repository builds a unified view of the program which can be updated and inspected by various tools. However, distribution of the compilation process to remote agents potentially disrupts the construction of this whole-program view.

Consequently some changes are needed to the repository scheme, as illustrated by FIG. 8. In this figure S_{N} refers to source code, T_{N} refers to tickets, and R_{N} refers to repositories.

To reduce the overhead of copying a (potentially very large) repository (R) to multiple remote build agents before the build can begin, a “Condense” phase extracts fragment digests (e.g. just hashes) to produce a minimal repository (r) which lacks the majority of the fragment content. The minimal repository r is then pushed to each remote agent. The remote compilations then add fragments (with their digests) for new or modified functions to their local repository (Rn).

Once the remote operations are complete, these remote repositories are pulled from the agents and a “Merge” operation is carried out. This updates the original repository (R) with the results of the remote compilations (Rn) to produce the final repository (R0). The remote repositories may each contain a copy of a vague-linkage object: these unneeded duplicates are eliminated by the merge process.

Optionally in this embodiment, the central repository is hosted on a network server to facilitate distribution.

Compilation System

It will be appreciated that typically the compiler and linker will form a single compilation system. However, in principle the compiler and linker could be separate and unrelated products that operate independently, using the tickets and the data in the repository as their intermediary. Hence different compilers and different linkers adhering to the techniques disclosed herein are envisaged, but may co-operate to form an overall compilation system and methodology.

Summary

In a summary embodiment of the present invention, referring to FIG. 9 a compiler method for a compiler comprises: in a first step s91, obtaining a source code element from source code; in a second step s92, obtaining compiler options for compilation of the source code element; in a third step s93, applying a hash function to data representing the source code element and compiler options, to generate a first hash value specific to the combination of the source code element and compiler options; in a fourth step s94, searching a repository for the first hash value; if the first hash value is not found in the repository, in a fifth step s95, generating an object code fragment from the source code element using the compiler options; and in a sixth step s96, storing the generated object code fragment and first hash value in association with each other in the repository; whereas if the first hash value is found in the repository, in a seventh step s97, not generating an object code fragment from the source code element.

In a summary embodiment of the present invention, reference to FIG. 10, a linking method for a linker comprises: in a first step s101, receiving at a linker data identifying one or more object code fragments, the object code fragments each corresponding to a source code element compiled according to respective compiler options; in a second step s102 accessing the or each identified object code fragment from a repository of object code fragments; and in a third step s103 commencing a memory layout mapping of object code fragments to addresses.

Each of these methods may further incorporate steps corresponding to methods and techniques disclosed herein

Hardware and Software

Referring now to FIG. 11, a conventional computer may comprise a central processing unit 1010, working memory 1020 (e.g. RAM), storage 1030 (e.g. a hard disk, flash memory or other persistent storage means), and optionally a communication transceiver 1040 (for example a network port), all linked by a bus 1050.

The compiler, linker and any created repository may be held in storage between uses. The CPU may then run the compiler and/or linker together with the repository in working memory. The resulting executable code and/or repository may then be held again in storage, and/or communicated to a remote data store/computer via a network. Alternatively or in addition, in the case of a parallel implementation of the compiler, repository data may be shared via the network.

Consequently it will be appreciated that the methods and techniques described herein may be carried out on conventional hardware suitably adapted as applicable by software instruction or by the inclusion or substitution of dedicated hardware. Example hardware includes videogame consoles and console development platforms, PCs and servers.

Thus the required adaptation to existing parts of a conventional equivalent device may be implemented in the form of a computer program product comprising processor implementable instructions stored on a non-transitory machine-readable medium such as a floppy disk, optical disk, hard disk, PROM, RAM, flash memory or any combination of these or other storage media, or realised in hardware as an ASIC (application specific integrated circuit) or an FPGA (field programmable gate array) or other configurable circuit suitable to use in adapting the conventional equivalent device. Separately, such a computer program may be transmitted via data signals on a network such as an Ethernet, a wireless network, the Internet, or any combination of these or other networks.

### ANNEX—WORKED EXAMPLE

To provide further understanding and examples, FIGS. 12(a)-12(j) illustrate an example of compiling, modifying and recompiling source code using a compiler in accordance with an embodiment of the present invention.

The source code used in the example is small program consisting of three functions A.c, B.c and C.c, each of which occupies its own TU and is considered a source code element:

// A. c
int a(void) {

return 2;

}
// B. c
int b(void) {

return 3;

}
// C. c
extern int a(void ) ;
extern int b(void ) ;
int main( ) {

return a( ) + b( ) ;

}

This example illustrates how changes to the source code and subsequent recompilations are reflected in the repository's representation of the compiler output. Each compile, assemble, or link step can be considered as a single repository transaction as is shown in FIGS. 12(a)-(j).

i. Initial Compilation
(a) Compile A.c
(b) Modify a( )
(c) Compile A.c

Here the developer makes two attempts to create a build of their program. Before the first compilation of A.c, the repository is empty. The repository state after the initial compilation is shown in FIG. 12(a); a₁ represents the first version of function a( ), D(a₁) is the hash of a₁, and f(a₁) is the fragment corresponding to the function. The developer then chooses to modify A.c before recompiling the code. After the second compile, as can be seeing in FIG. 12(b) there are is a second version a₂ of function a( ) in the repository together with corresponding D(a₂) and f(a₂).

ii. The First Complete Compile and Link Iteration.
(a) Compile A.c
(b) Compile B.c
(c) Compile C.c
(d) Link

The compilation of A.c does not result in any new code being generated, since the compiler generates a hash identical to D(a₂), finds this already exist is in the repository and so bypasses the subsequent steps, as described previously herein.

By contrast, for the first compliations of B.c and C.c, there is no hash corresponding to D(b₁) or D(c₁) in the repository, and so their code fragments are generated. The repository then contains the two versions of A.c and one version of each of B.c and C.c, as shown in FIG. 12(c).

The static linker now performs the layout and output passes. It starts at the nominated entry point (main( ) in this example), traversing the digraph and assigning addresses to the members of each of the fragments encountered. The output phase copies the data to the output and applies the necessary fixups. Optionally the results of the layout phase could also be recorded in the repository at this stage, facilitating incremental links.

iii. Modify a( ), Recompile A.c and then Relink.

The developer now decides to modify function a( ) again. This results in a third version of a( ) being added the repository, as illustrated in FIG. 12(d).

iv. Restore a( ) to a Previous State, Recompile A.c and then Relink.

The developer changes their mind, and undoes the last change so as to revert to the second version of function a( ). The compiler identifies the earlier results using the generated hash, and so no code generation needs to be repeated. The result is illustrated in FIG. 12(e).

v. Move a( ) from A.c to B.c.

The developer decides to reorganize the source code slightly by moving the definition of a( ) from one translation unit to another. Otherwise, there is no functional change to the program.

This process involves modifying and re-compiling two source files, and so two potential orders can be considered:

Compile A.c followed by B.c then relink: after the recompilation of A.c, its corresponding TU is empty, as seen in FIG. 12(f). An attempt to link the repository in this state would result in an error because the fixup from f(c₁) to a( ) cannot be satisfied. Consequently, B.c is recompiled as shown in FIG. 12(g). Again, the definition of f(a₂) is available in the repository for re-use.

Compile B.c followed by A.c then relink: following the compilation of B.c the repository contents are shown in FIG. 12(h). An attempt to link the program at this stage would result in an error from the linker as there are two definitions of the global symbol a( ). Next, A.c is compiled as shown in FIG. 12(i). In each case, the definition of f(a₂) is again available in the repository for re-use.

vi. Modify the Definition of b( ) Such that it is Now Identical to a( ) then Recompile B.c and Relink.

The system recognizes that the repository already contains a fragment whose hash matches that of b( ). The existing definition can be re-used and no code generation is necessary, as seen from FIG. 12(j).

As can be seen from the above examples, once a fragment has been created, then as long as the originating function or data item in the source code corresponds to the fragment, it can be re-used again and again as the source code is developed, even when the function or data item is moved to different TUs.

This saves a considerable amount of processing overhead and delay in the development of program code by greatly reducing the amount of redundant code generation that occurs with each build of the developing program code, and enables the compiler to operate more efficiently, with a reduced processor and memory overhead.

It will be appreciated that whilst generating hashes and fragments based upon source code elements such as stand-alone functions and data items is particularly beneficial (because for example it reduces the likelihood of recompilation of any given fragment, and can also simplify linking by more directly aligning fragments to the program graph), in principle the above disclosed techniques could be applied to larger or more complex blocks of source code. Hence the term ‘source code element’ is not limited to code corresponding to a single vertex on a program digraph.

Similarly, it will be appreciated that whilst the above description uses the ‘C’ programming language as an illustrative example of a statically compilable language, the techniques disclosed herein are not limited to this language. Other non-limiting examples include Algol, Basic, C++, Objective-C, C#, Cobol, Delphi, Fortran, Java, Pascal, and Rust.

1. A method of compiling and linking, comprising the steps of:
obtaining at a compiler a source code element from source code;
obtaining compiler options for compilation of the source code element;
applying a hash function to data representing the source code element and compiler options, to generate a first hash value specific to the combination of the source code element and compiler options;
searching a repository for the first hash value;
if the first hash value is not found in the repository,
generating an object code fragment from the source code element using the compiler options; and
storing the generated object code fragment and first hash value in association with each other in the repository; whereas
if the first hash value is found in the repository,
not generating an object code fragment from the source code element;
generating a list identifying one or more object code fragments in the repository that when suitably combined form object code for the source code;
receiving at a linker data identifying one or more object code fragments, the object code fragments each corresponding to a source code element compiled according to respective compiler options;
accessing the or each identified object code fragment from a repository of object code fragments; and
commencing a memory layout mapping of object code fragments to addresses.

2. The method of claim 1, wherein the data representing the source code element comprises an intermediate representation of the source code.

3. The method of claim 1, wherein the data representing the compiler options incorporates inlining decisions made by the compiler.

4. The method of claim 1, comprising repeating the steps for any additional source code elements in the source code.

5. The method of claim 1, wherein the generated list is stored in the repository in association with a unique ID, and the unique ID is output for use by a linker.

6. The method of claim 1, in which the linker uses available correspondences between a graph representation of the program and the object code fragments to detect connections between fragments, instead of performing a scan function of those object code fragments.

7. The method of claim 6 in which the linker only duplicates into a working space those sections of object code fragments used in a final executable image.

8. The method of claim 1, in which a generated executable comprises one or more links corresponding to one or more object code fragments in the repository of object code fragments, and the method comprises the step of: loading debugging metadata directly from the one or more object code fragments in the repository of object code fragments, by a debugger.

9. A non-transitory, computer readable storage medium containing computer executable instructions adapted to cause a computer system to perform actions, comprising:
obtaining at a compiler a source code element from source code;
obtaining compiler options for compilation of the source code element;
applying a hash function to data representing the source code element and compiler options, to generate a first hash value specific to the combination of the source code element and compiler options;
searching a repository for the first hash value;
if the first hash value is not found in the repository,
generating an object code fragment from the source code element using the compiler options; and
storing the generated object code fragment and first hash value in association with each other in the repository; whereas
if the first hash value is found in the repository,
not generating an object code fragment from the source code element;
generating a list identifying one or more object code fragments in the repository that when suitably combined form object code for the source code;
receiving at a linker data identifying one or more object code fragments, the object code fragments each corresponding to a source code element compiled according to respective compiler options;
accessing the or each identified object code fragment from a repository of object code fragments; and
commencing a memory layout mapping of object code fragments to addresses.

10. A compiler and linker, comprising
an obtaining processor arranged to obtain a source code element from source code;
an obtaining processor arranged to obtain compiler options for compilation of the source code element;
a hashing processor arranged to apply a hash function to data representing the source code element and compiler options, thereby generating a first hash value specific to the combination of the source code element and compiler options;
a memory arranged to store a repository;
a search processor arranged to search the repository for the first hash value;
and if the first hash value is not found in the repository,
a generating processor is arranged to generate an object code fragment from source code element using the compiler options, and
the generating processor is arranged to store the generated object code fragment and first hash value in association with each other in the repository;
but if the first hash value is found in the repository,
the generating processor is arranged to not generate an object code fragment from source code element;
a list processor arranged to generate a list identifying one or more object code fragments in the repository that when suitably combined form object code for the source code;
an obtaining processor arranged to obtain the list identifying one or more object code fragments, the object code fragments each corresponding to a source code element compiled according to respective compiler options;
an accessing processor arranged to access the or each identified object code fragment from a repository of object code fragments; and
a layout processor arranged to perform memory layout mapping of object code fragments to addresses.
